(19) United States
(12) Patent Application Publication
(10) Pub. No.: US 2024/0399797 A1
(43) Pub. Date: Dec. 5, 2024

(54) TIRE

(71) Applicant: BRIDGESTONE CORPORATION, Chuo-ku, Tokyo (JP)

(72) Inventors: Hiroyuki MATSUMOTO, Chuo-ku, Tokyo (JP); Yoshio KAJI, Chuo-ku, Tokyo (JP); Hiroshi NOMURA, Chuo-ku, Tokyo (JP)

(73) Assignee: BRIDGESTONE CORPORATION, Chuo-ku, Tokyo (JP)

(21) Appl. No.: 18/693,153

(22) PCT Filed: May 6, 2022
(86) PCT No.: PCT/JP2022/019600

§ 371 Date: Mar. 19, 2024

(30) Foreign Application Priority Data
Oct. 28, 2021 (JP) 2021-176996

(51) Int. Cl. B60C 11/12; B60C 11/03

(52) U.S. Cl. CPC B60C 11/1236; B60C 11/1204; B60C 11/0306; B60C 2011/1213; B60C 2011/1227; B60C 2011/1254

(57) ABSTRACT

The tire 10 of this disclosure is characterized in that at least one of the land portions comprises at least one sipe unit 60, both ends of each of one sipe 6a and the other sipe 6b constituting a pair of sipes terminates in the land portion, the one sipe 6a and the other sipe 6b are arranged opposing each other in the tire circumferential direction and have long sides extending in the tire width direction, respectively, the one sipe 6a has a short side 62a extending from either end e1 of the long side 61a in the tire width direction to approach the other sipe 6b side, and the other sipe 6b has a short side 62b extending from the other end e2 of the long side 61b in the tire width direction to approach the one sipe 6a side.

### TECHNICAL FIELD

This disclosure relates to a tire.

### BACKGROUND

Conventionally, tires that have improved with on-ice gripping performance by arranging sipes at a high density while controlling a decrease in rigidity, are known (for example, Patent Document 1).

### CITATION LIST

### Patent Literature

PTL 1: JP 2005-186827 A1

### SUMMARY

### Technical Problem

However, in Patent Document 1, the control of rigidity reduction and the high-density arrangement of the sipes were not sufficiently balanced, and there was still room for improvement in on-ice gripping performance.

It is therefore an object of the present disclosure to provide a pneumatic tire with improved on-ice gripping performance.

### Solution to Problem

The gist structure of the invention is as follows.

A tire having at least one land portion on a tread surface of the tire, wherein
at least one of the land portions comprises at least one sipe unit consisting of a pair of sipes,
both ends of each of one sipe and the other sipe constituting the pair of sipes terminates in the land portion,
the one sipe and the other sipe are arranged opposing each other in the tire circumferential direction and have long sides extending in the tire width direction, respectively,
the one sipe has a short side extending from either end of the long side in the tire width direction to approach the other sipe side, and the other sipe has a short side extending from the other end of the long side in the tire width direction to approach the one sipe side.

### Advantageous Effect

According to the present disclosure, it is possible to provide a pneumatic tire with improved on-ice gripping performance.

### BRIEF DESCRIPTION OF THE DRAWINGS

In the accompanying drawings:

FIG. 1 schematically illustrates a developed view of the tread surface of a tire according to one embodiment of this disclosure;

FIG. 2 illustrates an enlarged view of the sipe unit in FIG. 1;

FIG. 3A is an illustration for explaining an arrangement of sipe units in FIG. 1;

FIG. 3B is an illustration for explaining another example of an arrangement of sipe units;

FIG. 4 illustrates an enlarged view of one of the block land portions in FIG. 1;

FIG. 5A illustrates a Comparative Example of a block land portion;

FIG. 5B illustrates a Comparative Example of a block land portion;

FIG. 5C illustrates a Comparative Example of a block land portion;

FIG. 5D illustrates an Example of a block land portion;

FIG. 5E illustrates an Example of a block land portion;

FIG. 5F illustrates an Example of a block land portion; and

FIG. 6 is a graph providing the block rigidity and the actual footprint area in the Comparative Examples and Examples illustrated in FIGS. 5A to 5F.

### DETAILED DESCRIPTION

Hereinafter, embodiments of a tire(s) according to the present disclosure will be described by way of example with reference to the drawings. Common components in each figure are given the same reference numerals.

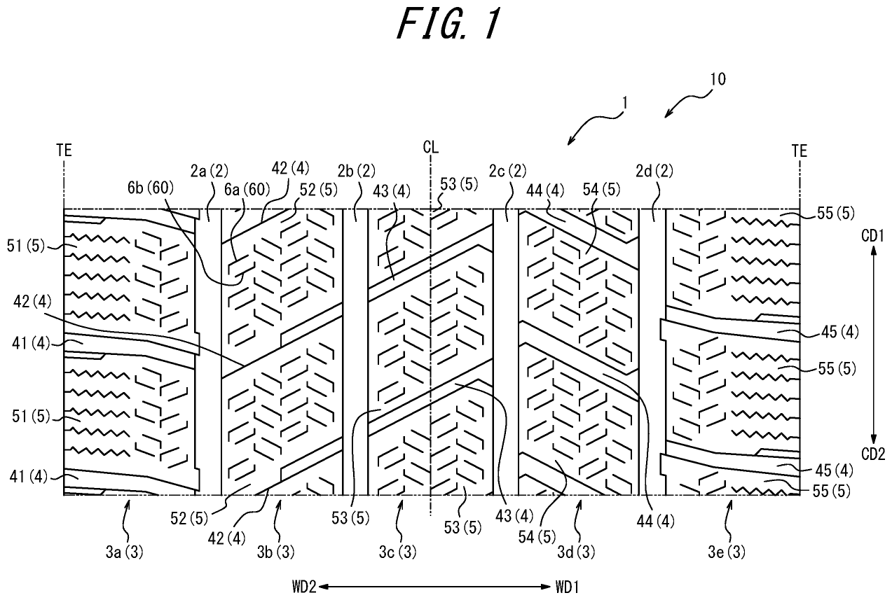

FIG. 1 schematically illustrates a developed view of the tread surface of a tire according to one embodiment of this disclosure.

In this document, the term “tread surface (1)” means the outer circumferential surface of the tire that is in contact with the road surface when the tire is assembled on a rim, filled with prescribed internal pressure, and rolled under a maximum load.

In addition, the term “tread edge (TE)” means the outer edge of the tread surface in the tire width direction.

As used herein, the term “applicable rim” refers to the standard rim in the applicable size (Measuring Rim in ETRTO's STANDARDS MANUAL and Design Rim in TRA's YEAR BOOK) as described or as may be described in the future in the industrial standard, which is valid for the region in which the tire is produced and used, such as JATMA YEAR BOOK of JATMA (Japan Automobile Tyre Manufacturers Association) in Japan, STANDARDS MANUAL of ETRTO (The European Tyre and Rim Technical Organization) in Europe, and YEAR BOOK of TRA (The Tire and Rim Association, Inc.) in the United States (That is, the “applicable rim” includes current sizes as well as future sizes to be listed in the aforementioned industrial standards.). An example of the “size as may be described in the future” could be the sizes listed as “FUTURE DEVELOPMENTS” in the ETRTO's STANDARDS MANUAL 2013 edition. For sizes not listed in these industrial standards, the term “applicable rim” refers to a rim with a width corresponding to the bead width of the tire.

In addition, the term “prescribed internal pressure” refers to the air pressure (maximum air pressure) corresponding to the maximum load capacity of a single wheel in the applicable size and ply rating, as described in the aforementioned JATMA YEAR BOOK and other industrial standards. In the case that the size is not listed in the aforementioned industrial standards, the term “prescribed internal pressure” refers to the air pressure (maximum air pressure) corresponding to the maximum load capacity specified for each vehicle in which the tire is mounted.

The term “maximum load” refers to the load corresponding to the above maximum load capacity.

Note, that the air as used herein can be replaced by inert gas such as nitrogen gas or other inert gas.

Unless otherwise noted herein, the dimensions of each element, such as grooves, sipes, block land portions, etc., shall be measured in the “reference condition” described below. The term “reference condition” refers to the condition in which the tire is assembled on the rim, filled with the above prescribed internal pressure, and unloaded. The dimensions of each element in the tread surface, such as grooves, sipes, and block land portions, etc., shall be measured in the developed view of the tread surface. Herein, the term “developed view of the tread surface” refers to a planar view of the tread surface with the tread surface developed on a flat surface.

In this document, the “groove width” shall be measured in a cross-section perpendicular to the extending direction of the grooves at the tread surface, parallel to the tread surface, in the above reference condition. The groove width may be constant or variable in the direction perpendicular to the tread surface. However, in this document, unless otherwise specified, the “groove width” refers to the groove width on the tread surface. The “groove depth” herein shall be measured in the direction perpendicular to the tread surface in the above reference condition.

In this document, the term “sipe” refers to a sipe whose width is 1 mm or less over a region of 50% or more of the sipe depth in the above reference condition. The sipe width is preferably 0.6 mm or less. Here, the “sipe depth” shall be measured perpendicular to the tread surface in the above condition, and the “sipe width” shall be measured in a cross-section perpendicular to the extending direction of the sipes at the tread surface, parallel to the tread surface, in the above reference condition. The sipe width may be constant or variable in the direction perpendicular to the tread surface.

In this document, the term “length of the short side along the extending direction thereof” of a sipe and the term “length of the long side along the extending direction thereof” of a sipe refer to the length of the centerline connecting the center points in the sipe width direction. The distance between each component of each sipe, etc., shall also be measured in the developed view of the tread surface with respect to the above centerline, unless otherwise noted.

In this document, for convenience, one side in the tire circumferential direction (the upper side in FIG. 1) is referred to as the “tire circumferential direction CD1 side” and the other side in the tire circumferential direction (the lower side in FIG. 1) as the “tire circumferential direction CD2 side”. Also, in this document, for convenience, one side in the tire width direction (right side in FIG. 1) is referred to as “tire width direction WD1 side” and the other side in the tire width direction (left side in FIG. 1) as “tire width direction WD2 side”.

The tire 10 according to one embodiment of this disclosure has at least one land portion on the tread surface 1. In the example illustrated in FIG. 1, the tire 10 of this embodiment has a plurality (four in the example illustrated) of circumferential main grooves 2 (2a, 2b, 2c, and 2d) extending in the tire circumferential direction on the tread surface 1. Each circumferential main groove 2 may extend in a substantially straight line along the tire circumferential direction, as illustrated in FIG. 1, or it may extend circumferentially in a zigzag or wavy shape, etc.

The groove width of each circumferential main groove 2 is not limited, but can be 4 to 15 mm, for example. Also, the depth of the circumferential main groove 2 is not limited, but can be 6 to 20 mm, for example.

In addition, the tire 10 of this embodiment has a plurality (five in the illustrated example) of land portions 3 (3a, 3b, 3c, 3d and 3e) defined by the circumferential main grooves 2a, 2b, 2c and 2d and the tread edges TE on the tread surface 1.

In this embodiment, each land portion 3 is divided into a plurality of block land portions 5 by a plurality of lateral grooves 4 extending in a direction that intersects the tire circumferential direction, respectively. In the example illustrated in FIG. 1, the land portion 3a has a plurality of block land portions 51, which are divided by the lateral grooves 41 and arranged along the tire circumferential direction. The land portion 3b has a plurality of block land portions 52, which are divided by the lateral grooves 42 and arranged along the tire circumferential direction. The land portion 3c has a plurality of block land portions 53, which are divided by the lateral grooves 43 and arranged along the tire circumferential direction. The land portion 3d has a plurality of block land portions 54, which are divided by the lateral grooves 44 and arranged along the tire circumferential direction. The land portion 3e has a plurality of block land portions 55, which are divided by the lateral grooves 45 and arranged along the tire circumferential direction.

Note, that each land portion 3 can be a rib-shaped land portion that is not defined by lateral grooves.

The groove width of each lateral groove 4 is not limited, but can be 2 to 10 mm, for example. Also, the groove depth of each lateral groove 4 is not limited, but can be 5 to 20 mm, for example.

In this embodiment, at least one sipe unit 60 comprising a pair of sipes 6a and 6b (hereinafter referred to as one sipe 6a and the other sipe 6b, or simply sipes 6a and 6b) is disposed in at least one of the land portions, or in each block land portion 5 in the illustrated example. In the example illustrated in FIG. 1, the block land portions 52, 53, and 54 have 12 sipe units each, and the block land portions 51 and 55 have 6 sipe units respectively.

Note, that the tread surface 1 of the tire 10 of this embodiment is not limited to the example in FIG. 1, and may have any tread pattern as long as it has a sipe unit 60 comprising a pair of sipes 6a and 6b.

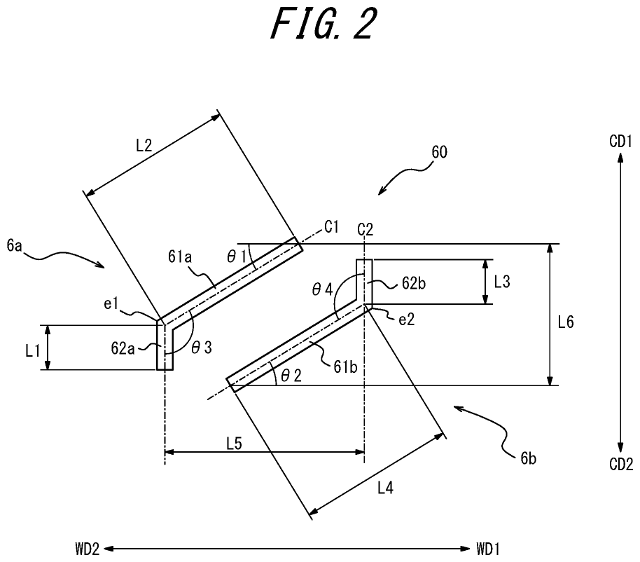

The sipe unit 60 in the tire 10 of this embodiment is described in detail with reference to FIG. 2. FIG. 2 illustrates an enlarged view of the sipe unit 60 in FIG. 1.

As illustrated in FIG. 2, the one sipe 6a and the other sipe 6b constituting the sipe unit 60 consisting of a pair of sipes, each terminate at both ends in the land portion (in this embodiment, in the block land portion 5).

In this embodiment, the one sipe 6a and the other sipe 6b are arranged opposing each other in the tire circumferential direction and have long sides extending in the tire width direction, respectively. In this embodiment, the one sipe 6a and the other sipe 6b each have a long side that extends at an angle with respect to the tire width direction, so that it goes toward one side in the tire circumferential direction as it goes toward one side in the tire width direction. More specifically, as illustrated in FIG. 2, the one sipe 6a and the other sipe 6b are spaced apart from each other and arranged with at least a portion (in this example, a portion) of each of them facing each other in the tire circumferential direction. In addition, as illustrated in FIG. 2, the one sipe 6a has a long side 61a that extends at an angle with respect to the tire width direction, so that it goes toward the tire circumferential direction CD1 side as it goes from the tire width direction WD2 toward the tire width direction WD1. The other sipe 6b has a long side 61b that extends at an angle with respect to the tire width direction, so that it goes toward the tire circumferential direction CD1 side as it goes from the tire width direction WD2 toward the tire width direction WD1. In this way, both long sides 61a and 61b are inclined and extend rightward on the paper by sloping toward the tire circumferential direction CD1 side as it goes from the tire width direction WD2 side toward the tire width direction WD1 side.

Here, in this document, “extending in the tire width direction” means extending with at least a tire width direction component. That is, “extending in the tire width direction” means that it may extend in a direction along the tire width direction (i.e., at an angle of 0° with respect to the tire width direction and without inclination to the tire width direction) or may extend at an angle with respect to the tire width direction (i.e., at an angle of more than 0° with respect to the tire width direction and with inclination to the tire width direction).

In the illustrated example, the long sides 61a and 61b have the same inclination angles θ1 and 02 relative to the tire width direction and are inclined at the same angle, but they may be inclined at different angles.

The one sipe 6a has a short side 62a extending from the end e1 of either side (the tire width direction WD2 side in the example illustrated in the figure) of the long side 61a in the tire width direction to approach the other sipe 6b side. As illustrated in FIG. 2, the short side 62a extends toward the side where the one sipe 6a and the other sipe 6b face each other to form a folding angle θ3 with the long side 61a.

The other sipe 6b has a short side 62b extending from the end e2 of the other side of the either side (the tire width direction WD1 side in the example illustrated in the figure) of the long side 61b in the tire width direction to approach the other sipe 6a side. As illustrated in FIG. 2, the short side 62b extends toward the side where the one sipe 6a and the other sipe 6b face each other to form a folding angle θ4 with the long side 61b.

Note, that in the one sipe 6a and the other sipe 6b, the short sides do not extend from the end of either side of the long sides 61a and 61b in the tire width direction where the short sides 62a and 62b described above are not provided.

The following is an explanation of the effects of the tire configuration of the first embodiment.

The one sipe 6a and the other sipe 6b terminate at both ends within the land portion (within the block land portion 5 in this embodiment), respectively, thereby preventing the formation of open ends of the sipes at the edges of the block land portion 5 and leaving the land portion connected around the ends of the sipes 6a and 6b. This increases the rigidity of the block land portion compared to the case where the sipes are open to the edge(s) of the block land portion. In this way, the block land portion 5 can improve on-ice performance because deformation thereof is controlled, lifting on the tread surface is prevented, and the actual footprint area with the road surface can be increased.

Also, in this embodiment, the sipes 6a and 6b are arranged opposing each other in the tire circumferential direction and have long sides 61a and 61b that extend at an angle with respect to the tire width direction, so that it goes toward one side in the tire circumferential direction as it goes toward the one side in the tire width direction, thereby the edge component of the long sides not only provides sufficient braking and driving force in the tire circumferential direction (front-back direction), but also contributes to improved lateral grip performance in the tire width direction. In particular, by setting the inclination angles θ1 and θ2 to 45° or less, the component in the tire width direction of the long side of the sipes becomes equal to or greater than the component in tire circumferential direction, which contributes to the improvement of braking and driving force, the most important factor for safety.

In this embodiment, the sipes 6a and 6b have short sides 62a and 62b extending from the long sides 61a and 61b, respectively, toward the side where the one sipe 6a and the other sipe 6b face each other. According to this configuration, when a thin metal plate (blade) is used in the mold to form a sipe in the manufacturing process of the tire 10, since the short side of the blade provides support for the long side against folding deformation that causes the long side of the blade to collapse, the bending rigidity of the blade can be greatly increased to improve blade durability and tire productivity.

As described above, according to this embodiment, it is possible to increase land rigidity (and thus actual footprint area) while maintaining sipe density, i.e., to achieve both land rigidity and high-density sipe arrangement, thereby improving on-ice gripping performance.

The following is a description of suitable configurations and variations in the tire 10 of this embodiment.

In this tire 10, the sipe depth of the one sipe 6a and the other sipe 6b is not particularly limited, but from the viewpoint of more effectively improving on-ice gripping performance, it is preferably 3 mm or more, for example, and it may be 10 mm or less.

In the tire 10 of this embodiment, it is preferable that the long sides of the one sipe 6a and the other sipe 6b extend parallel to each other and the short sides of the one sipe 6a and the other sipe 6b extend parallel to each other. As illustrated in FIG. 2, the long sides 61a and 61b extend parallel to each other and the short sides 62a and 62b extend parallel to each other. In addition, in the tire 10 of this embodiment, the one sipe 6a and the other sipe 6b are preferably arranged offset in the tire width direction. In FIG. 2, the sipes 6a and 6b are arranged in such a way that, when viewed along the tire circumferential direction in the developed view of the tread surface 1, the sipes 6a and 6b overlap each other in a part in the tire width direction and are arranged in a phase shifted in the tire width direction (i.e., not overlapping in a part in the tire width direction).

By arranging the long sides and short sides of the sipes 6a and 6b in parallel each other, the distance between the long sides and the short sides can be kept constant in the tire circumferential direction and in the tire width direction, respectively, thus making it easy to form a uniform and high-density arrangement of the sipe units 60 in the block land portion 5 without creating unnecessary voids. In addition, by offsetting the one sipe 6a and the other sipe 6b in the tire width direction, when the sipe unit 60 is viewed along the tire circumferential direction in the developed view of the tread surface 1, the sipes will be present over a wider area in the tire width direction, compared to the case where the one sipe 6a and the other sipe 6b are not offset. This allows the braking and driving force due to the edge component to be fully exerted over a wider area in the tire width direction, and also allows for uniform distribution regarding the ground contact pressure in the block land portion 5.

In the tire 10 of this embodiment, the long sides 61a and 61b of the sipes 6a and 6b, respectively, are preferably extend at the inclination angles θ1 and θ2 of 0° or more and 45° or less with respect to the tire width direction, and more than 0° and less than 45° are more preferred. By setting the inclination angles θ1 and θ2 to 0° or more and 45° or less, the braking and driving force in the tire circumferential direction (front-back direction) due to the edge component on the long sides are fully demonstrated. By setting the inclination angles θ1 and θ2 to more than 0°, the edge effect can also be obtained in the tire width direction, and by setting the inclination angles θ1 and θ2 to less than 45°, the braking and driving force in the tire circumferential direction (front-back direction) due to the edge component on the long sides can be more fully demonstrated.

In the tire 10 of this embodiment, it is preferable that the angle θ3 between the long side 61a and the short side 62a of the one sipe 6a and the angle θ4 between the long side 61b and the short side 62b of the other sipe 6b, respectively, is 90° or more on the side where the one sipe 6a and the other sipe 6b face each other. According to this configuration, when a blade is used in the mold to form a sipe in the manufacturing process of the tire 10, since the short side of the blade provides more effective support for the long side against folding deformation that causes the long side of the blade to collapse, the bending rigidity of the blade can be increased more effectively to improve blade durability and tire productivity. Also, by setting the angles θ3 and θ4 to 90° or more, it is possible to prevent the formation of an acute corner in the land portion near the apex formed by the intersection of the long and short sides, i.e., the formation of a local low-rigidity portion, so that to control deformation around this portion, prevent the difference in ground contact pressure from increasing, and more effectively demonstrate braking and driving force in the tire circumferential direction.

In addition, the angles θ3 and θ4 are preferably 150° or less. By setting the angles θ3 and θ4 to 150° or less, a moderate bend is formed between the short and long sides, which improves the durability of the blade that forms the sipes during tire manufacturing, compared to when the angles are greater than 150°.

Further, in the tire 10 of this embodiment, in each of the one sipe 6a and the other sipe 6b, the short sides 62a and 62b preferably extends along the tire circumferential direction. Note, that the term “extend along the tire circumferential direction” shall include cases where it is parallel to the tire circumferential direction or inclined at a very low angle with respect to the tire circumferential direction (e.g., inclined at an angle of 5° or less with respect to the tire circumferential direction). According to this configuration, sipes that can exert braking and driving force in response to inputs in the tire circumferential direction can be more efficiently arranged, and since the direction of the short sides approximately coincide with the input direction of the braking and driving forces, the block land portion is not divided with respect to the input direction and the reduction in rigidity of the land portion around the short sides can be more effectively controlled. In addition, according to this configuration, water that accumulates on the long sides of the sipes by removing the water film on the ice surface can be efficiently guided to the tire circumferential direction, which is the sliding direction during braking, by the short sides of the sipes provided at the end of the long sides, which extend along the tire circumferential direction, thereby promoting drainage.

Note, that when the short sides 62a and 62b extend along the tire circumferential direction, the angles θ3 and θ4 are preferably 90° or more and 135° or less, from the view point of forming an appropriate bend between the short side and the long side to more effectively improve the durability of the blade that forms the sipe during tire manufacturing, and ensuring that the edge component of the long side provides sufficient braking and driving forces in the tire circumferential direction (front-back direction). As mentioned above, by setting the inclination angle of the long sides with respect to the tire width direction to 0 to 45°, maximum effect can be achieved on the most important safety feature, the braking and driving performance. In order to maintain this angle while having the short side generally follow the tire circumferential direction, the bending angle between the long and short sides must be 90 to 135°. In the tire 10 of this embodiment, for example, the inclination angles θ1 and θ2 of the long sides 61a and 61b are 30°, and the angles θ3 and θ4 are 120°.

In the tire 10 of this embodiment, the one sipe 6a and the other sipe 6b are preferably congruent with each other. This configuration facilitates the uniform and high-density arrangement of the sipe units 60 in the block land portion 5. Here, “congruent” refers to congruence including mirror images, and means that they completely overlap each other due to parallel movement, rotational movement, and/or axisymmetric movement when viewed from the tread surface.

In the tire 10 of this embodiment, in each of the one sipe 6a and the other sipe 6b, the ratio of the length of the long sides 61a and 61b along the extending direction thereof to the length of the short sides 62a and 62b along the extending direction thereof is 1 to 15. In FIG. 2, the ratio of the length L2 of the long side 61a along the extending direction thereof to the length L1 of the short side 62a along the extending direction thereof is preferably 1 to 15, and the ratio of the length L4 of the long side 61b along the extending direction thereof to the length L3 of the short side 62b along the extending direction thereof is preferably 1 to 15. According to this configuration, since the ratio of the length of the long side to the short side is 1 or more, an excessive decrease in sipe density or an excessive decrease in land rigidity can be controlled, and since the ratio of the length of the long side to the short side is 15 or less, the durability of the blades that form the sipes during tire manufacturing can be improved.

In the tire 10 of this embodiment, the lengths L2 and L4 of the long sides 61a and 61b along the extending direction thereof are not particularly limited, but from the viewpoint of maintaining the rigidity of the block land portion 5 while fully demonstrating on-ice performance in the tire, and of enabling application to various types of tires, they are preferably 3 to 15 mm.

In the tire 10 of this embodiment, the lengths L1 and L3 of the short sides 62a and 62b along the extending direction thereof are also not particularly limited, but from the viewpoint of more effectively improving the durability of the blade that forms the sipes during tire manufacturing, they are preferably 1 mm or more, and less than the value of the lengths L2 and L4 of the long sides 61a and 61b along the extending direction thereof.

In addition, in the tire 10 of this embodiment, the ratio of tire circumferential length L6 along the tire circumferential direction of the sipe unit 60 to tire widthwise length L5 along the tire width direction of the sipe unit 60 is preferably 0.1 to 2.6. Here, the “tire widthwise length along the tire width direction” is the tire widthwise length along a straight line parallel to the tire width direction, and in FIG. 2, it refers to the distance between the end on the tire width direction WD2 side of the centerline C1 of the sipe 6a and the end on the tire width direction WD1 side of the centerline C2 of the sipe 6b. Also, the “circumferential length along the tire circumferential direction” is the tire circumferential length along a straight line parallel to the tire circumferential direction, and in FIG. 2, it refers to the distance between the end on the tire circumferential direction CD1 side of the centerline C1 of the sipe 6a and the end on the tire circumferential direction CD2 side of the centerline C2 of the sipe 6b. When the value of this ratio is 0.1 or more, the circumferential distance between the sipes does not become too short, and block rigidity can be more fully ensured. Furthermore, when the value of this ratio is 2.6 or less, the inclination angles θ1 and θ2 of the long sides 61a and 61b do not become excessive or the length of the long sides 61a and 61b in the tire width direction becomes too short, and more sufficient effect on the braking and driving force can be obtained.

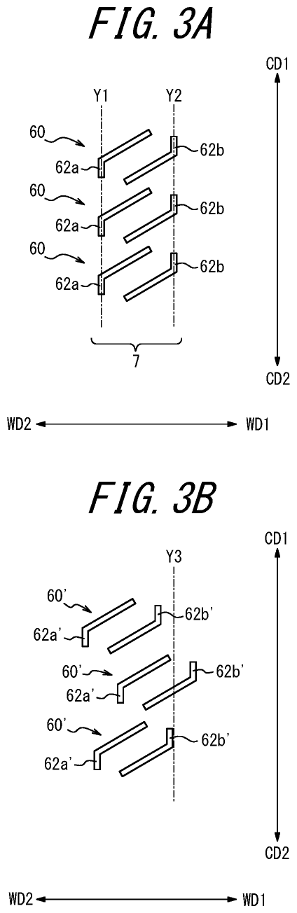

FIG. 3A is an illustration for explaining an arrangement of the sipe unit 60 in FIG. 1. In the tire 10 of this embodiment, when a plurality of sipe units 60 are arranged adjacent to each other in the tire circumferential direction to form a sipe unit row 7, as illustrated in FIG. 3A, it is preferable that in the plurality (in the illustrated example, three) of sipe units 60 arranged in the sipe unit row 7, the plurality (in this example, all) of short sides 62a arranged adjacent to each other in the tire circumferential direction extend on a same straight line along the tire circumferential direction (in FIG. 3A, on the hypothetical line Y1 along the tire circumferential direction), and the plurality (in this example, all) of short sides 62b arranged adjacent to each other in the tire circumferential direction extend on a same straight line along the tire circumferential direction (in FIG. 3A, on the hypothetical line Y2 along the tire circumferential direction). As illustrated in FIG. 3A, the adjacent sipe units 60 are spaced apart from each other and are arranged to face each other in the tire circumferential direction. Also, the “plurality of short sides 62a” and the “plurality of short sides 62b” above refer to all “short sides 62a” and “short sides 62b” contained within the sipe unit row 7 (in the illustrated example, there are three short sides 62a and three short sides 62b). According to this configuration, since the phases in the tire width direction of the plurality of sipe units 60 arranged adjacent to each other in the tire circumferential direction are aligned, it becomes easy to arrange a plurality of sipe units uniformly and at high density without forming unnecessary voids in the block land portion 5.

FIG. 3B is an illustration for explaining an another example of an arrangement of sipe units 60. As illustrated in FIG. 3B, when a plurality of sipe units 60′ are arranged adjacent to each other in the tire circumferential direction, in the plurality of sipe units 60′ arranged adjacent to each other in the tire circumferential direction, the plurality of short sides 62a′ arranged adjacent to each other in the tire circumferential direction may each extend parallel to the hypothetical line Y3 extending along the tire circumferential direction and may be offset in the tire width direction. Together with that, the plurality of short sides 62b′ arranged adjacent to each other in the tire circumferential direction may each extend parallel to the hypothetical line Y3 extending along the tire circumferential direction and may be offset in the tire width direction.

In the tire 10 of this embodiment, the number and density of the sipe units 60 arranged on each block land portion 5 is not particularly limited. As described above, in the example illustrated in FIG. 1, 12 sipe units 60 are arranged in each of the block land portions 52, 53 and 54, and 6 sipe units 60 are arranged in each of the block land portions 51 and 55.

The total number of one sipe and the other sipe that comprise the sipe unit 60 arranged on a block land portion 5 may be determined based on, for example, the sipe density SD described below.

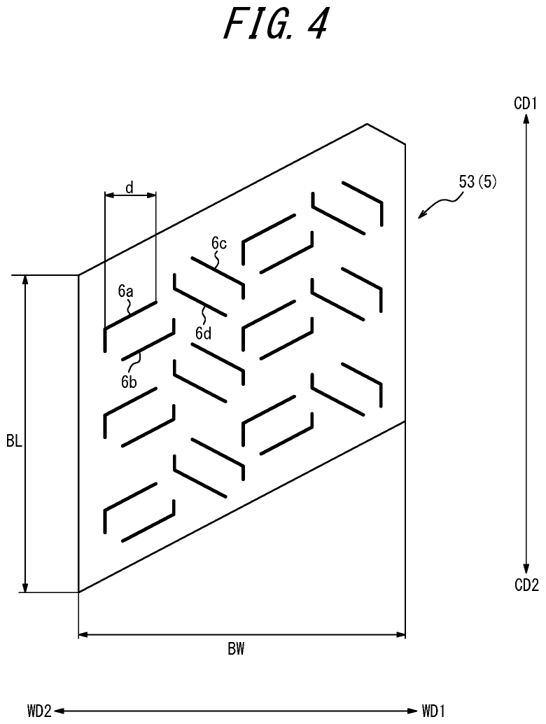

Hereinafter, a method for calculating the sipe density SD will be explained. FIG. 4 is an enlarged view of one of the block land portions 53 in FIG. 1. As illustrated in FIG. 4, when the block land portion 53 in FIG. 1 is a typical example of the block land portion 5: the total number of the sipes 6a (one sipe), 6b (the other sipe), 6c (one sipe) and 6d (the other sipe) in the block land portion 5 is n; the length of each of the sipes 6a, 6b, 6c, and 6d in the tire width direction is d (mm) (in FIG. 4, the length of the sipe 6a in the tire width direction is illustrated as d); and the depth of sipes 6a, 6b, 6c, and 6d is h (mm); d×h can be 150 (mm²) or less, for example. In addition, when the maximum length of the block land portion 5 in the tire width direction is BW (mm), the number of equivalent sipes N is expressed as d×n/BW. Here, the number of equivalent sipes N is the number of sipes 6a, 6b, 6c, and 6d in this embodiment when converted to transverse sipes (equivalent sipes) that are provided to completely cross the block land portion 5. Furthermore, when the equivalent length of the land portion in the tire circumferential direction is BL (mm), which is obtained by dividing the outer contour area of the block land portion 5 (mm²) by the aforementioned BW (mm), the average sipe spacing is expressed as BL/(N+1). Here, the average sipe spacing is the spacing of the equivalent sipes in the tire circumferential direction in the block land portion 5 when the sipes 6a, 6b, 6c, and 6d in this embodiment are converted to the equivalent sipes. The sipe density SD is expressed as the inverse of the average sipe spacing by the following equation.

$$SD = ( N + 1 ) / BL = ( ( d \times n / BW ) + 1 ) / BL \qquad ( Equation 1 )$$

Note, that the total number of the sipes in the block land portion n, the length of each of the above sipes in the tire width direction d, the maximum length of the block land portion in the tire width direction BW, and the outer contour area of the block land portion are the values measured in the developed view of the tread surface. The “outer contour area” of the block land portion means the area enclosed by the outer contour of the block land portion in the developed view of the tread surface, and therefore, even if non-ground contact portions such as sipes, small holes, narrow grooves, etc. are disposed within the block land portion, the area that does not exclude the area of the sipes, small holes, narrow grooves, etc. are considered.

For example, a plurality of sipes 6a, 6b, 6c and 6d may be arranged in the block land portion 5 so that the sipe density SD is 0.15 or more. This allows the sipe density to be increased while preventing a reduction in the rigidity of the land portion, thereby more effectively improving the on-ice gripping performance of the tire.

### EXAMPLES

Examples of the present disclosure will be described below, but the present disclosure is not limited thereto.

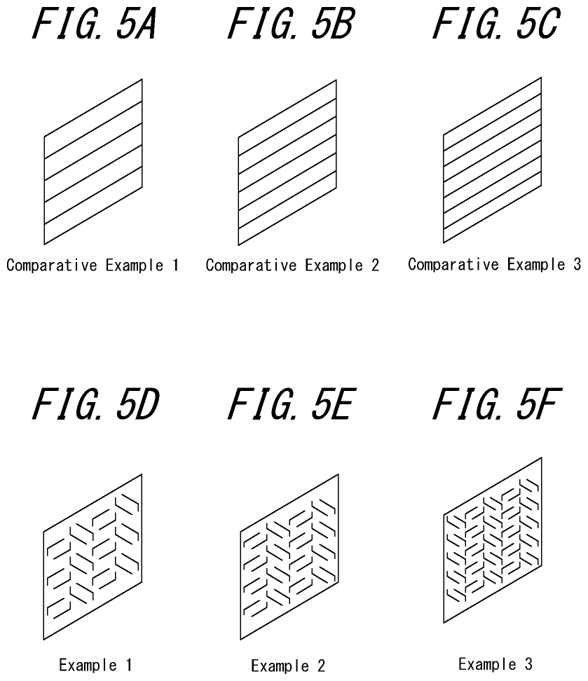

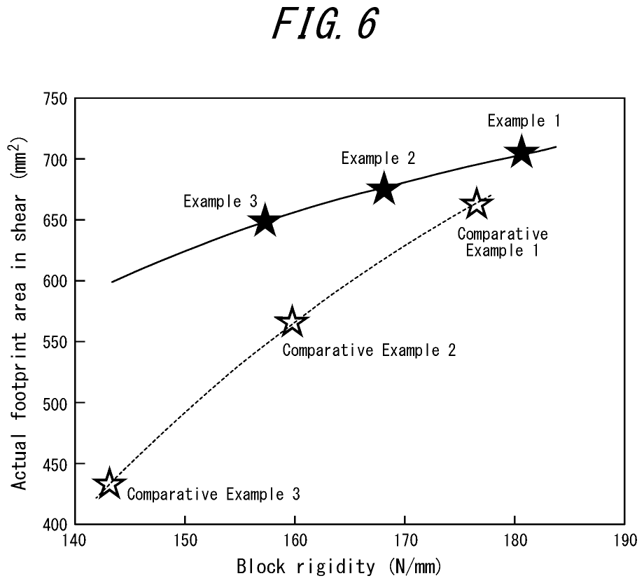

The effect on controlling lifting on a footprint of the test tires 1 to 6 (Comparative Examples 1 to 3 and Examples 1 to 3) was calculated by the Finite Element Method (FEM). Each test tire has the block land portions illustrated in Table 1 and FIGS. 5A to 5F on the tread surface, respectively. The results in the Comparative Examples and Examples presented in Table 1 and FIG. 5 are provided graphically in FIG. 6. As provided in FIG. 6, the horizontal axis of the graph is the block rigidity (N/mm), and the vertical axis of the graph is the actual footprint area in shear (mm²).

The predictive calculations by FEM were performed under the condition of applying a vertical load which is obtained by multiplying the outer contour area of the block land portion by a standard ground pressure for passenger vehicle tires of 230 kPa, and thereby evaluating the block rigidity and footprint area.

For the block rigidity, the shear input value in the tire circumferential direction when the lateral displacement in the same direction was 1 mm, was determined; and for the actual footprint area, the residual footprint area with partial lifting when the shear input in the tire circumferential direction was 0.3 times the above vertical load, was determined.

According to the results in FIG. 6, it can be seen that: even if the number of sipes and thus the sipe density are the same (between Comparative Example 1 and Example 1, Comparative Example 2 and Example 2, and Comparative Example 3 and Example 3, respectively), the block rigidity and the actual footprint area are greater in the Examples, which in turn has a greater effect on the control of lifting on the footprint of the block land portion, and resulting in improved on-ice gripping performance.

TABLE 1

| | Test tire | Test tire | Test tire | | | |
|---|---|---|---|---|---|---|
| | (Comparative | (Comparative | (Comparative | Test tire | Test tire | Test tire |
| | Example 1) | Example 2) | Example 3) | (Example 1) | (Example 2) | (Example 3) |
| Sipe shape | FIG. 5A | FIG. 5B | FIG. 5C | FIG. 5D | FIG. 5E | FIG. 5F |
| Average sipe spacing | 6 mm | 5 mm | 4.29 mm | 6 mm | 5 mm | 4.29 mm |
| Sipe density | 0.167/mm | 0.2/mm | 0.23/mm | 0.167/mm | 0.2/mm | 0.23/mm |
| Sipe width | 0.5 mm | 0.5 mm | 0.5 mm | 0.5 mm | 0.5 mm | 0.5 mm |
| Sipe depth | 6.7 mm | 6.7 mm | 6.7 mm | 6.7 mm | 6.7 mm | 6.7 mm |
| Number of sipes | 4 | 5 | 6 | Equivalent to 4 | Equivalent to 5 | Equivalent to 6 |

### INDUSTRIAL APPLICABILITY

The pneumatic tires of the present disclosure can be used for any type of pneumatic tire, but can suitably be used for passenger vehicle tires or truck/bus tires, and even more suitably for winter passenger vehicle tires or winter truck/bus tires.

### REFERENCE SIGNS LIST

1 Tread surface
2, 2a, 2b, 2c, 2d Circumferential main groove
3, 3a, 3b, 3c, 3d, 3e Land portion
4, 41, 42, 43, 44, 45 Lateral grooves
5, 51, 52, 53, 54, 55 Block land portion
6a Sipe (one sipe)
6b Sipe (the other sipe)
6c Sipe (one sipe)
6d Sipe (the other sipe)
7 Sipe row
10 Tire
60, 60′ Sipe unit
61a, 61b Long side
62a, 62a′, 62b, 62b′: Short side
C1, C2 Center line
WD1, WD2 Tire width direction
CD1, CD2 Tire circumferential direction
TE Tread edge
Y1, Y2, Y3 hypothetical line
d Length of sipe in the tire width direction

1. A tire having at least one land portion on a tread surface of the tire, wherein
at least one of the land portions comprises at least one sipe unit consisting of a pair of sipes,
both ends of each of one sipe and the other sipe constituting the pair of sipes terminates in the land portion,
the one sipe and the other sipe are arranged opposing each other in the tire circumferential direction and have long sides extending in the tire width direction, respectively,
the one sipe has a short side extending from either end of the long side in the tire width direction to approach the other sipe side, and
the other sipe has a short side extending from the other end of the long side in the tire width direction to approach the one sipe side.

2. The tire according to claim 1, wherein the long sides of the one sipe and the other sipe extend parallel to each other and the short sides of the one sipe and the other sipe extend parallel to each other, and the one sipe and the other sipe are arranged offset in the tire width direction.

3. The tire according to claim 1, wherein in each of the one sipe and the other sipe, an angle between the long side and the short side is 90° or more on the side where the one sipe and the other sipe face each other.

4. The tire according to claim 1, wherein in each of the one sipe and the other sipe, the short side extends along the tire circumferential direction.

5. The tire according to claim 1, wherein the one sipe and the other sipe are congruent with each other.

6. The tire according to claim 1, wherein in each of the one sipe and the other sipe, the ratio of length of the long side along the extending direction thereof to length of the short side along the extending direction thereof is 1 to 15.

7. The tire according to claim 1, wherein the ratio of tire circumferential length along the tire circumferential direction of the sipe unit to tire widthwise length along the tire width direction of the sipe unit is 0.1 to 2.6.

8. The tire according to claim 1, wherein a plurality of the sipe units are arranged adjacent to each other in the tire circumferential direction to form a sipe unit row, and
in the plurality of the sipe units in the sipe unit row, the short sides of a plurality of the one sipe of a plurality of the pair of sipes extend on a same straight line along the tire circumferential direction, and the short sides of a plurality of the other sipe of a plurality of the pair of sipes extend on a same straight line along the tire circumferential direction.

9. The tire according to claim 2, wherein in each of the one sipe and the other sipe, an angle between the long side and the short side is 90° or more on the side where the one sipe and the other sipe face each other.

10. The tire according to claim 2, wherein in each of the one sipe and the other sipe, the short side extends along the tire circumferential direction.

11. The tire according to claim 3, wherein in each of the one sipe and the other sipe, the short side extends along the tire circumferential direction.

12. The tire according to claim 2, wherein the one sipe and the other sipe are congruent with each other.

13. The tire according to claim 3, wherein the one sipe and the other sipe are congruent with each other.

14. The tire according to claim 4, wherein the one sipe and the other sipe are congruent with each other.

15. The tire according to claim 2, wherein in each of the one sipe and the other sipe, the ratio of length of the long side along the extending direction thereof to length of the short side along the extending direction thereof is 1 to 15.

16. The tire according to claim 3, wherein in each of the one sipe and the other sipe, the ratio of length of the long side along the extending direction thereof to length of the short side along the extending direction thereof is 1 to 15.

17. The tire according to claim 4, wherein in each of the one sipe and the other sipe, the ratio of length of the long side along the extending direction thereof to length of the short side along the extending direction thereof is 1 to 15.

18. The tire according to claim 5, wherein in each of the one sipe and the other sipe, the ratio of length of the long side along the extending direction thereof to length of the short side along the extending direction thereof is 1 to 15.

19. The tire according to claim 2, wherein the ratio of tire circumferential length along the tire circumferential direction of the sipe unit to tire widthwise length along the tire width direction of the sipe unit is 0.1 to 2.6.

20. The tire according to claim 3, wherein the ratio of tire circumferential length along the tire circumferential direction of the sipe unit to tire widthwise length along the tire width direction of the sipe unit is 0.1 to 2.6.
